(19) United States
(12) Patent Application Publication
(10) Pub. No.: US 2002/0130729 A1
(43) Pub. Date: Sep. 19, 2002

(54) Circuit and method improving linearity, and reducing distortion, in microwave RF bandpass filters, especially superconducting filters

(76) Inventors: Lawrence Larson, Del Mar, CA (US); Robert Hammond, Santa Barbara, CA (US); Balam Willemsen, Ventvna, CA (US); David Chase, Santa Barbara, CA (US); Peter Asbeck, San Diego, CA (US)

Correspondence Address: FUESS & DAVIDENAS, Suite II-G, 10951 Sorrento Valley Road, San Diego, CA, 92121-1613, US

(21) Appl. No.: 09/808,913

(22) Filed: Mar. 14, 2001

(51) Int. Cl. H01P 1/20; H01B 12/02

(52) U.S. Cl. 333/99 S; 333/202; 505/210

(57) ABSTRACT

In a bandpass filter circuit usable at the front end of a cellular microwave radio receiver, and particularly suitable for implementation with high temperature superconductor transmission lines, an rf input signal is split in a first coupler into a major first portion and a minor second portion. A first bandpass filter of inevitable non-linearity receives the first signal portion and produces therefrom a first-bandpass-filtered signal having distortion products collectively of a first power. A second bandpass filter having substantially identical passband and noise characteristics to, but with a non-linearity much greater than, the first bandpass filter receives the second signal portion of the input signal and produces therefrom a second-bandpass-filtered signal which has distortion products substantially collectively equal to the first power. A phase reverser reverses the phase of the second-bandpass-filtered signal relative to the first-bandpass-filtered signal, and the signals are coupled in a second coupler to produce a bandpass-filtered output signal in which the distortion products are substantially canceled.

The first-bandpass-filtered is preferably amplified in first low noise amplifier, and the second-bandpass-filtered amplified in a second low noise amplifier of variable gain as well as being phase reversed in a phase reverser of variable phase, both so as to (i) “fine tune” the circuit, and (ii) overcome a slight trade-off that is made in the sensitivity of the bandpass filter circuit to the input signal.

### REFERENCE TO A RELATED PATENT APPLICATION

The present patent application is related to U.S. patent application Serial No. AAA,AAA filed on an even date herewith for a CIRCUIT AND METHOD IMPROVING LINEARITY, AND REDUCING DISTORTION, IN MICROWAVE RF BANDPASS FILTERS, ESPECIALLY SUPERCONDUCTING FILTERS to inventors including all inventors of the present application. The contents of the related patent application are incorporated herein by reference.

### BACKGROUND OF THE INVENTION

1. Field of the Invention

The present invention generally concerns microwave rf filters, particularly as are implemented from high-temperature superconductors.

The present invention particularly concerns circuits and techniques for improving linearization, and reducing distortion, in microwave rf filters, including but not limited to high-temperature superconducting filters, particularly as are used in low-noise receiver applications.

2. Description of the Prior Art

One of the most important aspects of the implementation of a high performance base station for wireless communications applications is the low-noise receiver front-end, which typically takes the received rf signal from the antenna, and amplifies it before sending it onto the microwave receiver circuit. The key to the performance of this receiver circuit is that it should amplify the signal without adding significant noise or distortion. At the same time, a bandpass filter is employed between the antenna and the amplifier to remove any unwanted signals out of band from causing distortion of the desired signal later on.

The bandpass filter is a key component of the overall receiver, since any noise or distortion added by this filter results in irreversible corruption of the desired signal. Recently, high temperature superconductors have been used to implement these filters because of their superior loss and noise characteristics compared to traditional cavity resonator approaches. However, the distortion of these high temperature superconductor filters is relatively large, limiting their usefulness for a broad range of applications in the wireless area.

These high temperature superconductor bandpass filters would benefit from some form of improvement that would serve to reduce distortion without substantially adding to noise. Such is the subject of the present invention.

### SUMMARY OF THE INVENTION

The present invention contemplates a method, and a circuit, for filtering radio frequency (rf) signals with improved linearization, and reduction of distortion. The present invention is especially useful for use with existing filters that intrinsically have high distortion such as, at the present time (circa 1999), transmission line rf bandpass filters made from high temperature semiconductors (HTS). These HTS bandpass filters—although possessed of superior loss and noise characteristics—are relatively non-linear, thus producing relatively large distortion in the signals that they serve to filter.

The present invention employs a feed-forward approach that serves to cancel out non-linearities in a bandpass rf filter network. This cancellation permits improvement in the dynamic range of the filtering, most particularly in bandpass filtering as transpires microwave rf receiver circuits. This improvement in dynamic range is a desired characteristic in wireless communications systems operating in an increasingly crowded radio spectrum.

1. General Explanation

In outline, the present invention is embodied in an improved method of, and an improved bandpass filter circuit for, bandpass filtering (1) an input signal to produce (2) a bandpass-filtered output signal.

The bandpass filtering commences by splitting, in a first signal coupler, the (1) input signal into (1a) a major first signal portion and (1b) a minor second signal portion.

The (1a) first, major, signal portion is first-filtered in a first bandpass filter to produce a (1a1) first-bandpass-filtered first signal portion. The first filter having an inevitable non-linearity, the (1a1) first-bandpass-filtered first signal portion that it produces is inevitably possessed of some distortion. This distortion particularly includes intermodulation products including third-order intermodulation products. For purposes of the present invention, it should be taken that the third-order intermodulation products are of a first power.

Meanwhile, the (1b) second, minor, signal portion is second-bandpass-filtered in second bandpass filter, producing a (1b1) second-bandpass-filtered second signal portion. Notably, this second bandpass filter—although having as passband, noise and frequency response characteristics that are as nearly identical to the first bandpass filter as is possible—is intentionally made to have a non-linearity that is much greater than is the non-linearity of the first filter. Thus, even though this second filter operates on only but the (1b) minor, second, split portion input signal, the (1b1) second-bandpass-filtered second signal portion that it serves to produce possesses a third-order intermodulation product that is also substantially of the first power.

The (1b1) second-bandpass-filtered second signal portion is reversed in phase (relative to the (1a1) first-bandpass-filtered first signal portion) in a phase reverser, producing a (1b1) phase-reversed second-bandpass-filtered second signal portion.

Finally, this (1b1) phase-reversed second-bandpass-filtered second signal portion is coupled, or recombined, with the (1a1) first-bandpass-filtered first signal portion in a second signal coupler, producing the (2) output signal.

This coupling, or recombination, is in a manner so as to cancel as best as is possible the third-order intermodulation product. The bandpass-filtered output signal thus produced exhibits reduced distortion, and the non-linearity of the bandpass filtering is effectively obviated.

The price paid for this reduced distortion, and this improved bandpass-filtering linearity, is a slight reduction in the minimum detectable input signal at the input to the bandpass filter circuit, and to the bandpass filtering method, of the present invention. This is because a small portion of the input signal has been diverted, and fed forward to the second bandpass filter. However, even this reduction in sensitivity can be overcome, and the minimum detectable signal of a receiver employing at its front end the bandpass filter circuit and filtering method of the present invention can actually be enhanced over a passive bandpass filter if low-noise amplifiers (LNAs) are added in the signal paths of each of the first and the second bandpass filters. In this variant the dc power consumption of the bandpass filter circuit is increased, but the tradeoff of power for reduced signal distortion is normally a good one.

2. A Bandpass Filter Circuit

Therefore, in one of its aspects, the present invention is embodied in a bandpass filter circuit for producing a bandpass-filtered output signal from an input signal. This bandpass filter circuit includes the following:

A first coupler splits the input signal into a first portion and a second portion. (As discussed in the eighth paragraph following, this first signal portion is preferably, and commonly, much, much greater than is the second signal portion. It is normally—depending upon the filter technology used, and the ability to implement a bandpass filter of enhanced non-linearity as immediately next discussed—some_db greater.)

A first bandpass filter—a filter that is subordinate to, and part of, the bandpass filter circuit that it helps to implement—possessed of a first-filter non-linearity receives the first portion of the input signal. This first bandpass filter produces from this first portion of the input signal a first-bandpass-filtered signal. This first-bandpass-filtered signal is, due to the non-linearity of the first bandpass filter, inevitably possessed of distortion. This distortion includes (first-filter) intermodulation products that include (first-filter) third-order intermodulation products. These first-filter third-order intermodulation products have such power as is defined to be a “first power”.

A second bandpass filter has (i) substantially identical passband and noise and frequency response characteristics to the first bandpass filter but (ii) a non-linearity that is much greater than is the non-linearity of the first bandpass filter. This second bandpass filter receives the second portion of the input signal and produces therefrom a second-bandpass-filtered signal. This signal also will inevitably have distortion; a distortion that includes (second-filter) intermodulation products that include (second-filter) third-order intermodulation products. These second-bandpass-filter third-order intermodulation products have such power as is defined to be a “second power”.

In accordance with the present invention, proportionality between the first bandpass filter and the second bandpass filter is adjusted, principally in and by the manner of construction of each filter, so that the second power equals, insofar as is possible, the first power (and vice versa).

Next in the bandpass filter circuit, a phase reverser serves to reverse the phase of the second-bandpass-filtered signal relative to the first-bandpass-filtered signal (or vice versa).

Finally, a second coupler couples the phase-reversed second-bandpass-filtered signal to the first-bandpass-filtered signal so as to produce a bandpass-filtered output signal. This coupling of phase-reversed signals is in a manner so as to cancel (as best as is possible) the first-bandpass-filter third-order intermodulation products by and with the second-bandpass-filter third-order intermodulation products, both of which products are of substantially equal power.

By this cancellation, the inevitable non-linearity of each bandpass filter, and the distortion of the signals bandpass-filtered signal by each bandpass filter, is effectively improved in the final bandpass-filtered output signal.

As a further refinement of this bandpass filter, the phase reverser can be made to be adjustable in the phase shift that it imparts. By suitable adjustment of the phase reverser a cancellation of the third-order intermodulation products of the first-bandpass-filtered signal by the third-order intermodulation products of the phase-reversed second-bandpass-filtered signal in the second coupler may be optimized to conditions.

In order to that sensitivity of the bandpass filter circuit to the input signal may be best preserved, the first coupler normally splits the input signal into a major first portion and a minor second portion.

As yet another refinement to the bandpass filter circuit, a first amplifier—preferably a low noise amplifier (LNA)—is located between the first bandpass filter and the second coupler, there serving to amplify the first-bandpass-filtered signal. A like second amplifier is located between the second bandpass filter hand the second coupler, there serving to amplify the second-bandpass-filtered signal. Especially when the first coupler is splitting the input signal into a major first portion and a minor second portion, the linearity requirements placed on the second amplifier are modest because it is amplifying a second-bandpass-filtered signal that is relatively smaller than is the first-bandpass-filtered signal.

The second low noise amplifier is preferably adjustable in gain. By this adjustment of gain the ensuing cancellation of the third-order intermodulation products of the first-bandpass-filtered signal by the third-order intermodulation products of the phase-reversed second-bandpass-filtered signal in the second coupler may be optimized.

The first, and the second, amplifiers are each preferably a low noise amplifier (as noted), and are more preferably made from a superconductor transmission line.

The product, and operation, the bandpass filter circuit can be mathematically quantified. The third order intermodulation products distortion products of any bandpass filter n are conventionally expressible as

Pᵢₘ=kₙpᵢₙ^{m}

where kₙ is a constant of proportionality for filter n, and M is a constant which varies between 1.5 and 3 depending upon various physical factors in the filter. Know also that kₙ has a strong frequency dependence which is also linked to the particular realization of the filter.

In accordance with this form of expression, the first bandpass filter preferably has an third-order intermodulation product output power equalling

Pᵢₘ₁=k₁((1−α)pᵢₙ)^{m}

The second bandpass filter has an third-order intermodulation product output power equalling

Pᵢₘ₂=k₂((α)pᵢₙ)^{m}

The intermodulation products of the bandpass-filtered output signal are thus equal, as is the preferred condition for the reduced-distortion increased-linearity bandpass filter of the present invention when:

k₂k₁(1−α/α)^{m}(1−β/β)

Recall that kₙ has a strong frequency dependence which is linked to the particular realization of the filter. Since the frequency dependence of k₁ and k₂ should be well matched, both filters should be realized in a similar, and preferably in an identical, fashion.

By this construction and adjustment, the signal power at the output of the filter circuit has been decreased by about a factor of (1−α) (1−β), and the noise power has been decreased at the output of the filter circuit has been increased by approximately a factor of β. Accordingly, the noise factor has been increased by approximately the ratio of (the increase in noise power) to the (decrease in signal power).

All this has but a slight effect on minimum detectable power of the input signal. However, the minimum detectable input signal is slightly compromised, and this consideration should be kept in mind when using the bandpass filter circuit of the present invention. In crowded modern cellar radio communications networks it is generally more useful to perform bandpass filtering (at a time prior to signal amplification) at low noise than to preserve every microjoule of received rf power.

2. A Method of Bandpass Filtering

In another of its aspects, the present invention is embodied in a bandpass filtering method for producing a bandpass-filtered output signal from an input signal. The method includes the following steps:

The input signal is split in a first coupler into a major portion and a minor portion.

A primary, first, bandpass filter—having an inevitable first-filter non-linearity—filters the major portion of the input signal to produce therefrom a first-bandpass-filtered signal. This first-bandpass-filtered signal inevitably has distortion, which distortion includes first-filter intermodulation products that are themselves include first-filter third-order intermodulation products. For purposes of comparison, these first-filter third-order intermodulation products are defined to be of a “first power”.

A secondary second bandpass filter—having a substantially identical passband and noise characteristics to the first bandpass filter but having a second-bandpass-filter non-linearity that is much greater than is the first-bandpass-filter non-linearity—filters the minor portion of the input signal, producing therefrom a second-bandpass-filtered signal. This signal also has distortion, including second-filter intermodulation products that themselves include second-filter third-order intermodulation products. These second-filter third-order intermodulation products are defined to be of a “second power”.

In accordance with the present invention, each of the first bandpass filter and the second bandpass filter are adjusted, normally by construction, so that there is a proportionality therebetween, to wit: the second power should equal insofar as is possible the first power.

The phase of the second-bandpass-filtered signal relative to the first-bandpass-filtered signal is reversed in a phase reverser.

Finally, the phase-reversed second-bandpass-filtered signal is coupled in a second coupler to the first-bandpass-filtered signal, producing the bandpass-filtered output signal. This coupling of phase-reversed signals is in a manner so as to cancel, as best as is possible, the first-filter third-order intermodulation products by and with the second-filter third-order intermodulation products that are of substantially equal power.

This cancellation improves the linearity, and reduces the distortion, of the bandpass filtering while having but a slight effect on minimum detectable power of the input signal.

As a further refinement of the bandpass filtering method, the phase reversing is preferably adjustable in phase shift. By so adjusting the phase shift of the phase reversing a cancellation of the third-order intermodulation products of the first-bandpass-filtered signal by the third-order intermodulation products of the phase-reversed second-bandpass-filtered signal in the second coupler may be optimized.

To enhance the method it is preferable to perform the further steps of first-amplifying the first-bandpass-filtered signal in a first low noise amplifier, located between the first bandpass filter and the second coupler, and second-amplifying the second bandpass filtered signal in a second low noise amplifier, located between the second bandpass filter and the second coupler.

In this enhanced method the second-amplifying is preferably adjustable in gain. By adjustment of the gain of the second-amplifying a cancellation of the third-order intermodulation products of the first-bandpass-filtered signal by the third-order intermodulation products of the phase-reversed second-bandpass-filtered signal in the second coupler may be optimized.

These and other aspects and attributes of the present invention will become increasingly clear upon reference to the following drawings and accompanying specification.

### BRIEF DESCRIPTION OF THE DRAWINGS

FIG. 1 is a schematic diagram showing a first, basic, embodiment of a bandpass filter circuit in accordance with the present invention.

FIG. 2 is a schematic diagram showing a second, enhanced, embodiment of a bandpass filter circuit in accordance with the present invention.

### DESCRIPTION OF THE PREFERRED EMBODIMENT

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

1. Bandpass Filter Circuits, and a Bandpass Filtering Method, in Accordance with the Present Invention

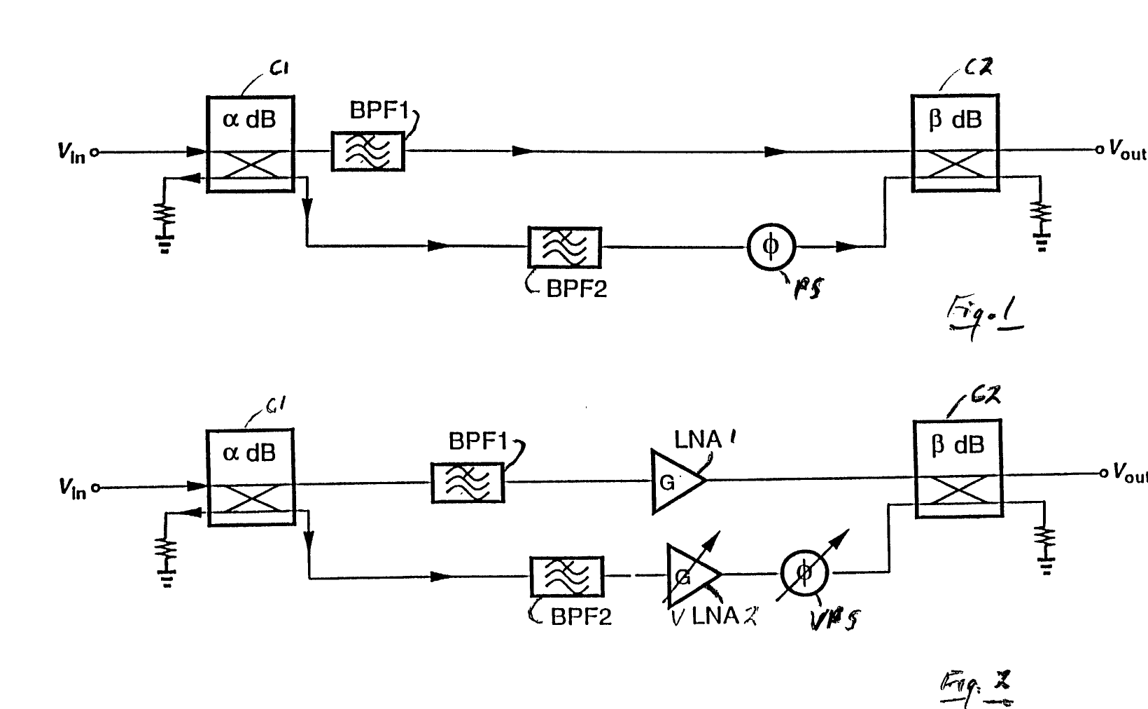

The bandpass filter circuit of the present invention is shown in its basic, rudimentary, embodiment in FIG. 1, and in an enhanced, preferred, embodiment in FIG. 2. In the case of each bandpass filter circuit a small portion of the power of an input signal Vᵢₙ that is sent to the first bandpass filter BPF1—normally from an antenna (not shown)—is coupled off in a coupler C1 and sent to a second bandpass filter BPF2. This BPF2 preferably has identical passband and noise characteristics to the first bandpass filter BPF1, but is substantially more nonlinear than the first bandpass filter BPF1.

Note that in most cases, a bandpass filter is desired to be as linear as possible, but in the case of the second bandpass filter BPF2 the filter has been intentionally adjusted to be relatively nonlinear. The non-linearity of the second bandpass filter BPF2 is straightforward to adjust by alteration of the physical design of the filter, it being easier to make an non-linear than a linear filter.

Each coupler C1 provides for removal of a small portion of the power that is within the input signal Vᵢₙ. This small portion is then passed through a highly nonlinear bandpass filter BPF2 having the same first-order transfer characteristics as does the first bandpass filter BPF1 (which is as the highly linear as is possible). In accordance with the present invention, this diverted (minor) portion of the input signal Vᵢₙ will ultimately be coupled back through another coupler C2 so as to form the output signal Vₒᵤₜ. The non-linearities in the output signal Vₒᵤₜ can be substantially canceled if the non-linearities of the second bandpass filter BPF2, and a phase shift induced by a phase shifter PS (or variable phase shifter VPS), are both properly chosen.

The theory of how this is realized is as follows. The third-order intermodulation products are assumed to be the dominant generators of distortion, and a general expression for these distortion products is given by:

pᵢₘ=kₙpᵢₙ^{m}

where kₙ is a constant of proportionality for filter n, and m is a constant, which varies between 1.5 and 3, depending on various physical factors in the filter. Note also that kₙ has a strong frequency dependence which is linked to the particular realization of the filter.

In the case of the present invention, the bandpass filter circuit is designed so that k₂>>k₁. Now, the coupler C1 at the input of the circuit has a coupling coefficient α, and the coupler C2 at the output has a coupling coefficient of β. Hence, the intermodulation power at the output of the first bandpass filter BPF1 is given by

Pᵢₘ₁=k₁((1−α)pᵢₙ)^{m}

and the intermodulation power at the output of the second bandpass filter BPF2 is given by

Pᵢₘ₂=k₂((α)pᵢₙ)^{m}

The intermodulation products at the final output signal Vₒᵤₜ of the filter circuit are equal when

k₂k₁(1−α/α)^{m}(1−β/β)

Note that the frequency dependence of k₁ and k₂ must also be well matched, which implies that both filters must be realized in a similar fashion in the same or in similar technologies and materials.

In addition, the desired signal power at the output of the filter circuit has been decreased by (1−α)(1−β) and the noise power at the output of the filter circuit has been increased by approximately β; making that the noise factor has been increased by approximately the ratio of the increase in noise power to the decrease in signal power.

All this slightly compromises the minimum detectable signal Vᵢₙ at the input of the filter circuit, but normally not so adversely so as to disqualify the bandpass filter circuit of the present invention from beneficial use.

In practice, the cancellation of the intermodulation products will not be perfect. Therefore, some amount of adjustment will be required in and by the cancellation occurring within the bandpass filter circuit in order to achieve the desired effect. This will require both gain and phase adjustments in order to achieve sufficient cancellation. Therefore, an enhanced, and preferred, embodiment of the bandpass filter circuit of the present invention is shown in FIG. 2.

In this embodiment, (i) a first low-noise amplifier LNA1 has been added at the output of first bandpass filter PBF1, and (ii) a second low-noise amplifier LNA2, and a variable phase shifter VPS, have been added at the output of second bandpass filter PBF2, in order to promote achievement of the desired cancellation. The addition of the low-noise amplifiers LNA1, LNA2 in both of the signal paths improves the minimum detectable signal of the bandpass filter circuit, and of any receiver for which the bandpass filter circuit serves as a “front end”. This improvement comes at the expense of increased dc power dissipation. However, in most cases this trade-off is a very desirable since the signal output Vₒᵤₜ of the filter circuit normally next feeds into the input low-noise amplifier of a receiver (both not shown) in any case, and power sufficient to energize low noise amplifiers is commonly available, or can readily be made available. Moreover, the linearity requirements on at least the second low-noise amplifier LNA2 at the output of the second bandpass filter BPF2 are very modest, since it is amplifying a relatively small signal.

Accordingly, a low-noise amplifier in each branch—i.e., the first low noise amplifier LNA1 in the first branch and the second low noise amplifier LNA2 in the second branch—lower the noise contribution from the linearization stage.

2. Practical Application of the Bandpass Filter Circuits, and Bandpass Filtering Method, of the Present Invention

Traditional “front-end” filters for cellular radio base stations employ cavity resonators as bandpass filters. Thee cavity resonator bandpass filter are physically bulky and exhibit high loss.

The superior loss and noise characteristics of thin-film superconducting bandpass filters offer dramatic improvements over these previous cavity resonator bandpass filters. However, the linearity, and resultant distortion, of thin-film superconducting bandpass filters is poor. The circuit of the present invention suffices to dramatically improve the effective linearity, and distortion in the output signal, resultant from the use of these thin-film superconducting bandpass filters.

In accordance with the preceding explanation, variations and adaptations of the circuit and method improving for linearity, and reducing distortion, in microwave rf bandpass filters, especially superconducting filters, in accordance with the present invention will suggest themselves to a practitioner of the electrical circuit, and rf filter, design arts. For example, the phase changer PS shown in FIG. 1 could operate in the first branch of the circuit, instead of it illustrated position within the second branch.

In accordance with these and other possible variations and adaptations of the present invention, the scope of the invention should be determined in accordance with the following claims, only, and not solely in accordance with that embodiment within which the invention has been taught.

What is claimed is:

1. A bandpass filter circuit for producing a bandpass-filtered output signal from an input signal, the bandpass filter circuit comprising:
a first coupler for splitting the input signal into a first portion and a second portion;
a first bandpass filter
having an inevitable first-filter non-linearity,
this first bandpass filter receiving the first portion of the input signal and producing therefrom a first-bandpass-filtered signal having inevitable distortion that includes first-filter intermodulation products that include first-filter third-order intermodulation products which first-filter third-order intermodulation products are collectively of a first power;
a second bandpass filter
having substantially identical passband and noise characteristics to the first bandpass filter but a second-filter non-linearity that is much greater than is the first-filter non-linearity,
this second bandpass filter receiving the second portion of the input signal and producing therefrom a second-bandpass-filtered signal having inevitable distortion that includes second-filter intermodulation products that include second-filter third-order intermodulation products which second-filter third-order intermodulation products are collectively of a second power;
wherein proportionality between the first bandpass filter and the second bandpass filter is adjusted in and by construction of each filter so that the second power equals insofar as is possible the first power;
a phase reverser for reversing the phase of the second-bandpass-filtered signal relative to the first-bandpass-filtered signal; and
a second coupler for coupling the phase-reversed second-bandpass-filtered signal to the first-bandpass-filtered signal to produce the bandpass-filtered output signal, the coupling of phase-reversed signals being in a manner so as to cancel as best as is possible the first-filter third-order intermodulation products by and with the second-filter third-order intermodulation products of substantially equal power;
wherein the inevitable non-linearity of the bandpass filter circuit has effectively been improved.

2. The bandpass filter circuit according to claim 1
wherein the phase reverser is adjustable in phase shift;
wherein by adjustment of the phase reverser a cancellation of the third-order intermodulation products of the first-bandpass-filtered signal by the third-order intermodulation products of the phase-reversed second-bandpass-filtered signal in the second coupler may be optimized to conditions.

3. The bandpass filter circuit according to claim 1
wherein the first coupler is splitting the input signal into a major first portion and a minor second portion.

4. The bandpass filter circuit according to claim 1 further comprising:
a first amplifier, located between the first bandpass filter and the second coupler, amplifying the first-bandpass-filtered signal; and
a second amplifier, located between the second bandpass filter and the second coupler, amplifying the second-bandpass-filtered signal.

5. The bandpass filter circuit according to claim 4
wherein the first coupler is splitting the input signal into a major first portion and a minor second portion;
wherein linearity requirements on the second amplifier are reduced relative to the second amplifier because is amplifying but the second-bandpass-filtered signal relatively smaller than is the first-bandpass-filtered signal.

6. The bandpass filter circuit according to claim 4
wherein the second low noise amplifier is adjustable in gain;
wherein by adjustment of the gain of the second low noise amplifier a cancellation of the third-order intermodulation products of the first-bandpass-filtered signal by the third-order intermodulation products of the phase-reversed second-bandpass-filtered signal in the second coupler may be optimized.

7. The bandpass filter circuit according to claim 4 wherein the first amplifier comprises:
a low noise amplifier;
and wherein the second amplifier comprises:
a low noise amplifier.

8. The bandpass filter circuit according to claim 1 wherein the first bandpass filter comprises:
a superconductor transmission line;
and wherein the second bandpass filter comprises:
a superconductor transmission line.

9. The bandpass filter circuit according to claim 1 where, when third order intermodulation products distortion products of any bandpass filter n are conventionally expressible as
Pᵢₘ=kₙpᵢₙ^{m}
where kₙ is a constant of proportionality for filter n, and where m is a constant which varies between 1.5 and 3 depending upon various physical factors in the filter, the first bandpass filter has an third-order intermodulation product output power equalling
Pᵢₘ₁=k₁((1−α)pᵢₙ)^{m}; and
the second bandpass filter has an third-order intermodulation product output power equalling
Pᵢₘ₂=k₂((α)pᵢₙ)^{m}.

10. The bandpass filter circuit according to claim 9 where intermodulation products of the bandpass-filtered output signal are equal in that
k₂=k₁(1−α/α)^{m}(1−β/β)

11. The bandpass filter circuit according to claim 10 where intermodulation products of the bandpass-filtered output signal are so equal because both bandpass filters are realized in an identical fashion in the same technology.

12. A bandpass filtering method for producing a bandpass-filtered output signal from an input signal, the bandpass filtering method comprising:
splitting in a first coupler the input signal into a major portion and a minor portion;
filtering, in a primary first bandpass filter having an inevitable first-filter non-linearity, the major portion of the input signal to produce therefrom a first-bandpass-filtered signal having inevitable distortion that includes first-filter intermodulation products that include first-filter third-order intermodulation products which first-filter third-order intermodulation products are collectively of a first power;
filtering, in a secondary second bandpass filter having a substantially identical passband and noise characteristics to the first bandpass filter but having a second-filter non-linearity that is much greater than is the first-filter non-linearity, the minor portion of the input signal to produce therefrom a second-bandpass-filtered signal having inevitable distortion that includes second-filter intermodulation products that include second-filter third-order intermodulation products which second-filter third-order intermodulation products are collectively of a second power;
adjusting by construction of each of the first and the second bandpass filter a proportionality therebetween so that the second power equals insofar as is possible the first power;
reversing in a phase reverser the phase of the second-bandpass-filtered signal relative to the first-bandpass-filtered signal; and
coupling in a second coupler the phase-reversed second-bandpass-filtered signal to the first-bandpass-filtered signal to produce the bandpass-filtered output signal, the coupling of phase-reverse signals being in a manner so as to cancel as best as is possible the first-filter third-order intermodulation products by and with the second-filter third-order intermodulation products of substantially equal power while having but a slight effect on minimum detectable power of the input signal;
wherein the inevitable non-linearity of the bandpass filtering has effectively been improved.

13. The bandpass filtering method according to claim 12
wherein the phase reversing is adjustable in phase shift;
wherein by adjustment of the phase shift of the phase reversing a cancellation of the third-order intermodulation products of the first-bandpass-filtered signal by the third-order intermodulation products of the phase-reversed second-bandpass-filtered signal in the second coupler may be optimized to conditions.

14. The bandpass filtering method according to claim 12 further comprising:
first amplifying the first-bandpass-filtered signal in a first low noise amplifier, located between the first bandpass filter and the second coupler; and
second amplifying the second-bandpass-filtered signal in a second low noise amplifier, located between the second bandpass filter and the second coupler.

15. The bandpass filtering method according to claim 14
wherein the second amplifying is adjustable in gain;
wherein by adjustment of the gain of the second amplifying a cancellation of the third-order intermodulation products of the first bandpass filtered signal by the third-order intermodulation products of the phase-reversed second bandpass filtered signal in the second coupler may be optimized to conditions.

16. A method of bandpass filtering an input signal to produce a bandpass-filtered output signal, the bandpass filtering method comprising:
splitting in a first coupler the input signal into a major first signal portion and a minor second signal portion;
first-filtering the first signal portion in a first filter to produce a first-filtered first signal portion having a third-order intermodulation product of a first power;
second-filtering the second signal portion in a second filter, which second filter has a non-linearity that is much greater than was a non-linearity of the first filter, to produce a second-filtered
second signal portion of substantially identical passband and noise characteristics to the first-filtered first signal portion and having a third-order intermodulation product also of substantially the first power;
phase reversing in a phase reverser the phase of the second-filtered second signal portion relative to the first-filtered first signal portion; and
coupling in a second coupler the phase-reversed second-filtered second signal portion and the first-filtered first signal portion in a manner so as to cancel as best as is possible the third-order intermodulation product to produce the bandpass-filtered output signal;
wherein the inevitable non-linearity of the bandpass filtering has effectively been improved.
